(19) United States
(12) Patent Application Publication
(10) Pub. No.: US 2021/0372496 A1
(43) Pub. Date: Dec. 2, 2021

(54) Composite Friction Lining Material

(71) Applicant: KNAUF INSULATION SPRL, Vise (BE)

(72) Inventors: Carl HAMPSON, Liverpool (GB); Paul YARR, Chester (GB)

(21) Appl. No.: 17/054,160

(22) PCT Filed: May 7, 2019
(86) PCT No.: PCT/EP2019/061697

§ 371 Date: Nov. 9, 2020

(30) Foreign Application Priority Data
May 8, 2018 (GB) 1807477.3

(51) Int. Cl. F16D 69/02; C08L 5/02; C08K 3/28; C08K 5/092

(52) U.S. Cl. CPC F16D 69/025; C08L 5/02; C08K 2003/322; C08K 5/092; C08K 3/28

(57) ABSTRACT

The present invention relates to a composite friction lining material comprising a friction mix and a binder resin, wherein the binder resin comprises a carbohydrate based binder resin, the carbohydrate based binder resin being obtained from a carbohydrate component and a cross-linker, wherein the cross-linker is selected from ammonium salts of inorganic acid, carboxylic acids, salts, for example ammonium salts thereof, ester or anhydride derivatives thereof, an amine component and/or combinations thereof.

The present invention relates to new composite friction lining materials intended for instance for brake pads and brake shoes or clutches.

Friction linings are the wearable surface component secured to a metallic backing in brake or clutch systems, including so-called drum and disc-brake systems, in automotive and other applications. Other applications are found in industry equipment, lifting equipment, marine and agricultural applications etc. The lining is generally made of a composite material composed of a friction mix the particles of which are bonded by a binder. The friction mix may vary depending on the intended use. It may contain for instance iron or other metal particles, synthetic fibers, ceramic particles and others, depending on the desired physical and mechanical characteristics. Friction mixes are complex mixes comprising up to 25 or more different materials. The friction lining is secured to a metal backing to form a brake pad or brake shoe or clutch disc. The lining should be heat-resistant as it converts kinetic energy into heat and show a high coefficient of dynamic friction, thereby showing good wear resistance while not excessively wearing off the counter (friction) surface, like the disc in disc brake systems or the drum in drum brake systems. The physical and/or mechanical characteristics may vary depending on the intended usage. As an example, linings for brake shoes used in drum brake systems are generally subject to less stringent conditions than linings for brake pads used in disc brake systems. Also, brake systems in truck vehicles and automobile vehicles are subject to different strain conditions, and brake systems in race cars need to respond to different requirements as compared to common street vehicles.

The binder used in known friction linings mostly is phenol or phenol formaldehyde based. The trend to more sustainable and environmentally friendly products has directed the development of such composite friction lining products away from the use of formaldehyde based binders towards the use of less hazardous compositions in terms of corrosivity and potential impact on production staff. Among such binders, carbohydrate-based binders represent an important share.

Carbohydrate based binders include binders obtained by the reaction of a carbohydrate with a nitrogenous compound, such as Maillard-type binders, by the reaction of a carbohydrate with an organic acid, and other binders obtained from starting materials that include a carbohydrate.

Carbohydrates are readily available in nature. Sources are animal derived products such as chitosan (derived from crustacean shells) and plant derived products, including but not limited to starch, syrup, molasses and cellulose. These carbohydrates also called polysaccharides are macromolecules made up by saccharide units. An advantageous source of carbohydrate raw materials can be found in recycled materials, such as recycled municipal solid waste, recycled paper and/or sugar cane bagasse, and/or wood. Depending on the source and/or on the hydrolysis process used to degrade the polysaccharides, different polysaccharides or polysaccharide compositions may be obtained. In certain applications, smaller molecules may be preferred, such as short chain polysaccharides, oligosaccharides or even saccharide units. Again, depending on the source and/or hydrolysis process conditions, different saccharides or saccharide mixtures may be obtained. While cellulose hydrolysis will generate essentially C6 sugars, preferably C-6 reducing sugars, e.g. dextrose, hemicellulose will generate a large fraction of C5 sugars, like xylose for instance.

It has now been found that the above disadvantages may be overcome by the use of appropriate carbohydrate based binder compositions in the manufacturing of composite friction lining materials.

The present invention hence provides new composite friction lining material comprising a friction mix and a binder resin, wherein the binder resin comprises a carbohydrate based binder resin, the carbohydrate based binder resin being obtained from a carbohydrate component and a cross-linker, wherein the cross-linker is selected from ammonium salts of inorganic acid, carboxylic acids, salts, for example ammonium salts thereof, ester or anhydride derivatives thereof, an amine component and/or combinations thereof.

When a polyester type resin binder is desired, the starting materials are selected from a carbohydrate component bearing hydroxy functional groups and compounds bearing carboxylic acid functional groups, or anhydride or salt derivatives thereof, such that upon curing under appropriate curing conditions the desired polyester resin is obtained. Such polyester based resins are well known in the technical field. The hydroxy functional compound may be selected from carbohydrates, such as dextrose, and the compound bearing carboxylic acid functional groups, or anhydride or salt derivatives thereof, may be selected from polycarboxylic acid, anhydride or salt thereof.

The polycarboxylic acid may advantageously be selected from monomeric and polymeric polycarboxylic acids. Illustratively, a monomeric polycarboxylic acid may be a dicarboxylic acid, including, but not limited to, unsaturated aliphatic dicarboxylic acids, saturated aliphatic dicarboxylic acids, aromatic dicarboxylic acids, unsaturated cyclic dicarboxylic acids, saturated cyclic dicarboxylic acids, hydroxy-substituted derivatives thereof, and the like. Or, illustratively, the polycarboxylic acid(s) itself may be a tricarboxylic acid, including, but not limited to, unsaturated aliphatic tricarboxylic acids, saturated aliphatic tricarboxylic acids, aromatic tricarboxylic acids, unsaturated cyclic tricarboxylic acids, saturated cyclic tricarboxylic acids, hydroxy-substituted derivatives thereof, and the like. It is appreciated that any such polycarboxylic acids may be optionally substituted, such as with hydroxy, halo, alkyl, alkoxy, and the like. In one variation, the polycarboxylic acid is the saturated aliphatic tricarboxylic acid, citric acid. Other suitable polycarboxylic acids are contemplated to include, but are not limited to, aconitic acid, adipic acid, azelaic acid, butane tetracarboxylic acid dihydride, butane tricarboxylic acid, chlorendic acid, citraconic acid, dicyclopentadiene-maleic acid adducts, diethylenetriamine pentaacetic acid, adducts of dipentene and maleic acid, ethylenediamine tetraacetic acid (EDTA), fully maleated rosin, maleated tall-oil fatty acids, fumaric acid, glutaric acid, isophthalic acid, itaconic acid, maleated rosin oxidized with potassium peroxide to alcohol then carboxylic acid, maleic acid, malic acid, mesaconic acid, biphenol A or bisphenol F reacted via the KOLBE-Schmidt reaction with carbon dioxide to introduce 3-4 carboxyl groups, oxalic acid, phthalic acid, sebacic acid, succinic acid, tartaric acid, terephthalic acid, tetrabromophthalic acid, tetrachlorophthalic acid, tetrahydrophthalic acid, trimellitic acid, trimesic acid, and the like, and anhydrides, and combinations thereof. Illustratively, a polymeric polycarboxylic acid may be an acid, for example, polyacrylic acid, polymethacrylic acid, polymaleic acid, and like polymeric polycarboxylic acids, copolymers thereof, anhydrides thereof, and mixtures thereof. Examples of commercially available polyacrylic acids include AQUASET-529 (Rohm & Haas, Philadelphia, Pa., USA), CRITERION 2000 (Kemira, Helsinki, Finland, Europe), NF1 (H.B. Fuller, St. Paul, Minn., USA), and SOKALAN (BASF, Ludwigshafen, Germany, Europe). With respect to SOKALAN, this is a water-soluble polyacrylic copolymer of acrylic acid and maleic acid, having a molecular weight of approximately 4000. AQUASET-529 is a composition containing polyacrylic acid cross-linked with glycerol, also containing sodium hypophosphite as a catalyst. CRITERION 2000 is an acidic solution of a partial salt of polyacrylic acid, having a molecular weight of approximately 2000. With respect to NF1, this is a copolymer containing carboxylic acid functionality and hydroxy functionality, as well as units with neither functionality; NF1 also contains chain transfer agents, such as sodium hypophosphite or organophosphate catalysts.

As described in U.S. Pat. Nos. 5,318,990 and 6,331,350, the polymeric polycarboxylic acid comprises an organic polymer or oligomer containing more than one pendant carboxy group. The polymeric polycarboxylic acid may be a homopolymer or copolymer prepared from unsaturated carboxylic acids including, but not necessarily limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Alternatively, the polymeric polycarboxylic acid may be prepared from unsaturated anhydrides including, but not necessarily limited to, maleic anhydride, itaconic anhydride, acrylic anhydride, methacrylic anhydride, and the like, as well as mixtures thereof. Methods for polymerizing these acids and anhydrides are well-known in the chemical art. The polymeric polycarboxylic acid may additionally comprise a copolymer of one or more of the aforementioned unsaturated carboxylic acids or anhydrides and one or more vinyl compounds including, but not necessarily limited to, styrene, α-methylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, vinyl methyl ether, vinyl acetate, and the like. Methods for preparing these copolymers are well-known in the art. The polymeric polycarboxylic acids may comprise homopolymers and copolymers of polyacrylic acid. The molecular weight of the polymeric polycarboxylic acid, and in particular polyacrylic acid polymer, may be is less than 10000, less than 5000, or about 3000 or less. For example, the molecular weight may be 2000.

When melanoïdin type binders are desired, the carbohydrate may include one or more reactants having one or more reducing sugars. In one aspect, any carbohydrate reactant should be sufficiently nonvolatile to maximize its ability to remain available for reaction with the amine reactant. The carbohydrate reactant may be a monosaccharide in its aldose or ketose form, including a triose, a tetrose, a pentose, a hexose, or a heptose; or a polysaccharide; or combinations thereof. A carbohydrate reactant may be a reducing sugar, or one that yields one or more reducing sugars in situ under thermal curing conditions. For example, when a triose serves as the carbohydrate reactant, or is used in combination with other reducing sugars and/or a polysaccharide, an aldotriose sugar or a ketotriose sugar may be utilized, such as glyceraldehyde and dihydroxyacetone, respectively. When a tetrose serves as the carbohydrate reactant, or is used in combination with other reducing sugars and/or a polysaccharide, aldotetrose sugars, such as erythrose and threose; and ketotetrose sugars, such as erythrulose, may be utilized. When a pentose serves as the carbohydrate reactant, or is used in combination with other reducing sugars and/or a polysaccharide, aldopentose sugars, such as ribose, arabinose, xylose, and lyxose; and ketopentose sugars, such as ribulose, arabulose, xylulose, and lyxulose, may be utilized. When a hexose serves as the carbohydrate reactant, or is used in combination with other reducing sugars and/or a polysaccharide, aldohexose sugars, such as glucose (i.e., dextrose), mannose, galactose, allose, altrose, talose, gulose, and idose; and ketohexose sugars, such as fructose, psicose, sorbose and tagatose, may be utilized. When a heptose serves as the carbohydrate reactant, or is used in combination with other reducing sugars and/or a polysaccharide, a ketoheptose sugar such as sedoheptulose may be utilized. Other stereoisomers of such carbohydrate reactants not known to occur naturally are also contemplated to be useful in preparing the binder compositions as described herein. When a polysaccharide serves as the carbohydrate, or is used in combination with monosaccharides, sucrose, lactose, maltose, starch, and cellulose may be utilized. The carbohydrate component may advantageously comprise oligomers or polymers that result from the hydrolysis of a polysaccharide, such as starch, cellulose or molasses. Such hydrolysates are capable of generating reducing sugars in situ and/or already comprise reducing sugars and further may contribute to the effect of the matrix polymer. Preferred are hydrolysates that show a DE of 25 to 90, preferably 35 to 85, or 45 to 85, most preferably 55 to 80.

The inorganic acid part of ammonium salt may advantageously be selected from phosphoric, sulphuric, nitric and carbonic acid. Ammonium sulphate and ammonium phosphate are preferred.

According to another embodiment, the cross-linker is selected from amine components or salts thereof, more specifically salts with an inorganic acid, such as sulfuric or phosphoric acid.

The amine component may advantageously be selected from polyamine functional compounds comprising primary and/or secondary amine functional groups. In illustrative embodiments, the polyamine is a primary polyamine. In one embodiment, the polyamine may be a molecule having the formula of H₂N-Q-NH₂, wherein Q is an alkyl, cycloalkyl, heteroalkyl, or cycloheteroalkyl, each of which may be optionally substituted. In one embodiment, Q is an alkyl selected from a group consisting of C₂-C₂₄. In another embodiment, Q is an alkyl selected from a group consisting of C₂-C₈. In another embodiment, Q is an alkyl selected from a group consisting of C₃-C₇. In yet another embodiment, Q is a C₆ alkyl. In one embodiment, Q is selected from the group consisting of a cyclohexyl, cyclopentyl or cyclobutyl. In another embodiment, Q is a benzyl. In illustrative embodiments, the polyamine is selected from a group consisting of a di-amine, tri-amine, tetra-amine, and penta-amine. In one embodiment, the polyamine is a diamine selected from a group consisting of 1,6-diaminohexane and 1,5-diamino-2-methylpentane. In a preferred embodiment, the di-amine is 1,6-diaminohexane. In one embodiment, the polyamine is a tri-amine selected from a group consisting of diethylenetriamine, 1-piperazineethaneamine, and bis(hexamethylene)triamine. In another embodiment, the polyamine is a tetra-amine such as triethylenetetramine. In another embodiment, the polyamine is a penta-amine, such as tetraethylenepentamine. In another embodiment, the polyamine is selected from polyethyleneimine (PEI), polyninyl amine, polyether amine, polylysine. As is known to the skilled person, several different types of polyethylenimines are available, such as linear polyethylenimines, branched polyethylenimines and dendrimer type polyethylenimine; all are suitable in the binder compositions of the invention. Similarly, polyetheramines may show a linear form and branched forms, and all are believed to be suitable for the generation of binder compositions and, hence, binders for use in the invention friction lining materials.

The amine component may further be selected from triprimary triamine(s), more specifically selected from:
triprimary triamine(s) having spacer groups between each of the three primary amines which consist of carbon chains;
triprimary triamine(s) having spacer groups between each of the three primary amines wherein each spacer group has a spacer length which is less than or equal to 12 polyvalent atoms; and
triprimary triamine(s) having a total number of polyvalent atoms which is less than or equal to 23.
   Such amine components comprise, and may consist essentially of or consist of, triprimary triamine(s) having spacer groups between each of the three primary amines which consist of carbon chains. The triprimary triamine(s) may be selected from the group consisting of triaminodecanes, triaminononanes, notably 4-(aminomethyl)-1,8-octanediamine, triaminooctanes, triaminoheptanes, notably 1,4,7-triaminoheptane, triaminohexanes, notably 1,3,6-triaminohexane, triaminopentanes, and including isomers and combination thereof. As used herein the term “triprimary triamine(s)” means organic compound having three and only three amines, each of the three amines being primary amines (—NH₂). One, two or each of the primary amine(s) of the triprimary triamine(s) may be present in the form of a salt, e.g. as an ammonium group (—NH₃⁺). As used herein, the term “spacer group” in the terminology “the spacer group(s) separating each of the three primary amines” means a chain separating two primary amines. As used herein, the term “the spacer group(s) separating each primary amines in the molecule consists of carbon chains” means that the spacer group(s) consist only of carbon atoms bonded to hydrogen atoms or bonded to other carbon atoms. The triprimary triamine(s) having spacer groups between each of the three primary amines which consist of carbon chains thus consist of the three primary amines and carbon and hydrogen atoms. For example, when the spacer group(s) separating each primary amine in the molecule consists of carbon chains, no heteroatoms are present in the spacer groups. The spacer group(s) may be selected from the group consisting of alkanediyls, heteroalkanediyls, alkenediyls, heteroalkenediyls, alkynediyls, heteroalkynediyls, linear alkanediyls, linear heteroalkanediyls, linear alkenediyls, linear heteroalkenediyls, linear alkynediyls, linear heteroalkynediyls, cycloalkanediyls, cycloheteroalkanediyls, cycloalkenediyls, cycloheteroalkenediyls, cycloalkynediyls and cycloheteroalkynediyls, each of which may be branched or unbranched. The spacer group(s) may be selected from the group consisting of alkanediyls, alkenediyls, alkynediyls, linear alkanediyls, linear alkenediyls, linear alkynediyls, cycloalkanediyls, cycloalkenediyls and cycloalkynediyls, each of which may be branched or unbranched. The spacer group may comprise or may be devoid of halogen atoms. The spacer groups may comprise or be devoid of aromatic groups. As used herein: the term “alkanediyl” means a saturated chain of carbon atoms ie without carbon-carbon double or triple bonds; the term “alkenediyl” means a chain of carbon atoms that comprises at least one carbon-carbon double bond; the term “alkynediyl” means a chain of carbon atoms that comprises at least one carbon-carbon triple bond; the term “cyclo” in relation to cycloalkanediyl, cycloalkenediyl and cycloalkynediyl indicates that at least a portion of the chain is cyclic and also includes polycyclic structures; and the term “linear” in relation to alkanediyls, alkenediyls and alkynediyls indicates an absence of a cyclic portion in the chain. As used herein, the term “hetero” in relation to heteroalkanediyls, heteroalkenediyls, heteroalkynediyls, linear heteroalkanediyls, linear heteroalkenediyls, linear heteroalkynediyls, cycloheteroalkanediyls, cycloheteroalkenediyls, and cycloheteroalkynediyls means that the chain comprises at least one polyvalent heteroatom. As used herein, the term heteroatom is any atom that is not carbon or hydrogen. As used herein, the term polyvalent atom means an atom that is able to be covalently bonded to at least 2 other atoms. The polyvalent heteroatom may be oxygen; it may be silicon; it may be sulfur or phosphorus. One, two or preferably each of the spacer groups may have a total number of polyvalent atoms, or a total number of carbon atoms which is ≥3, ≥4 or ≥5 and/or ≤12, ≤10 or ≤9. One, two or preferably each of the spacer groups may have a spacer length which is ≥3, ≥4 or ≥5 and/or ≤12, ≤10 or ≤9. As used herein, the term “spacer length” in relation to a spacer group separating two primary amines means the number of polyvalent atoms which form the shortest chain of covalently bonded atoms between the two primary amines. Each of the spacer groups between the three primary amines of the TPTA triprimary triamine(s) may: consist of an alkanediyl; and/or be linear; and/or be unbranched; and/or have a number of carbon atoms which is ≥3 or ≥4 and/or ≤9 or ≤3; and or have a spacer length which is ≥3 or ≥4 and/or ≤9 or ≤8. The total number of the polyvalent atoms of the TPTA triprimary triamine(s) may be ≥9, ≥11 or ≥12 and/or ≤23, ≤21, ≤19 or ≤17.

Further amine components may include carbamates and amino acids or proteins, such as lysine for instance.

The dry weight ratio of carbohydrate to cross-linker may range from 2 to 20, preferably from 2 to 15, more preferably from 2.5 to 10.

The binder composition leading to the binder resin may be a solid or a liquid composition. In any case, the active solids content of the binder composition should be relatively high, that is comprised between 55 and 100% by weight, preferably at least 60 or 65 or 70 w %, and no more than 80, 85, 90 or 95 w %, based on the total weight of the binder composition.

Such friction lining materials generally comprise 5 to 35 wt % resin, preferably 8-25 wt %.

If a solid binder composition is desired for the preparation of the binder resin, that composition may either be a mix of solid reaction components or solid reaction product, possibly obtained from a solution of the reaction products by drying techniques known per se. Liquid binder compositions may be preferred to “wet” fiber materials that are part of the friction mix.

As used herein, “ammonium” means NH₄⁺.

The term “binder composition” as used herein means all ingredients applied to the matter to be bound and/or present on the matter to be bound, notably prior to curing, (other than the matter and any moisture contained within the matter).

The term “binder” is used herein to designate a thermoset binder resin obtained from the “binder composition”.

The term “cured” means that the components of the binder composition have been subjected to conditions of temperature and/or pressure that lead to chemical change, such as covalent bonding, hydrogen bonding and chemical crosslinking, which may increase the cured product's durability and solvent resistance and result in thermoset material. Without being bound by theory, its is believed that the curing generates highly crosslinked high molecular weight polymers. These may be analysed by techniques generally known in the art, including determination of molecular weight, and other known techniques.

The term “dry weight of the binder composition” as used herein means the weight of all components of the binder composition other than any water that is present (whether in the form of liquid water or in the form of water of crystallization).

The term “crosslinker” as used herein comprises compounds that are capable of reacting with the carbohydrate component to form ramifications or reticulations of the said carbohydrate component.

Interesting results have been achieved with combinations of different cross-linkers, such as for instance a combination of ammonium salt of inorganic acid and organic acid, ester or salt thereof, preferably ammonium salt thereof.

The binder resin may further comprise a different resin, such as a phenol based resin, e.g. a phenolformaldehyde resin, or other resin known in the art.

In a further aspect, the present invention relates to a process for the manufacture of a composite friction lining material. The process may comprise intimately mixing the binder components of the binder composition and particulate materials of the friction mix, such as metal particles and/or ceramic particles, synthetic and/or mineral fibers, molding the obtained mixture and subjecting the mixture to heat and/or pressure in order to promote the reaction between the components of the binder composition and allowing for curing of the reaction product obtained, and further allowing the formed bonded composite lining material to cool. Curing may be effected at temperatures between ambient (from about 10 to 25° C.) and up to 280° C. or even up to 300° C. or 350° C. The skilled artisan will be in a position to adapt the curing temperature as appropriate, such as not to negatively affect the characteristics of the product to be obtained. Curing is generally effected under pressure, thereby also imposing the required shape to the obtained friction lining or element as required for the relevant application.

The binder composition may further comprise one or more adjuvants, for example coupling agents, waxes, dyes, release agents, antifungal and/or antibacterial agents, formaldehyde scavengers, hydrophobes and other adjuvants commonly used in binder compositions. Also, catalysts, such as mineral phosphorous-based salts and/or acids, such as phosphate or hypophosphite salts, may be added into the binder composition as catalysts of the resin forming reaction. Further, anti-caking additives, lubricants, such as fumed silica, dedusting oils, flame retardants, fillers and/or other additives currently used in binder compositions may also be used.

According to yet another aspect, the invention relates to a friction element, such as a brake pad, brake shoe, clutch disc or other friction element used in industry equipment, lifting equipment, marine applications, agricultural applications, and other applications, comprising a composite friction lining material as described above.

Further advantages of the invention will become apparent from the Examples herein below.

### EXAMPLE 1

A commonly used standard friction mix has been mixed with binder compositions exemplified below.
Solid compositions:
Solid binder compositions were prepared from dextrose monohydrate or 50/50 combinations of dextrose monohydrate and fructose or 34/51 combinations of dextrose monohydrate and sucrose, and ammonium sulphate or diammonium phosphate or 15/7.5 combinations of ammonium sulphate and diammonium phosphate. The solid compositions were ground together in an appropriate mill or grinder.

| Sample | DMH | Fructose | Sucrose | AS | DAP |
|---|---|---|---|---|---|
| Nbre 80 | 85 | | | 15 | |
| Nbre 82 | 42.5 | 42.5 | | 15 | |
| Nbr 84 | 85 | | | 15 | |
| Nbr 85 | 34 | | 51 | 15 | |
| Nbr 86 | 77.5 | | | 15 | 7.5 |
| Nbr 87 | 77.5 | | | 22.5 | |

DMH stands for dextrose monohydrate
AS stands for ammonium sulphate
DAP stands for diammonium phosphate
The numbers are shown in w % of the total weight of the binder composition.

Liquid Compositions:

The liquids were heated to dissolve in the appropriate quantity of water.

| sample | DMH | Fructose | HMDA | AS | TAC | DAP |
|---|---|---|---|---|---|---|
| Nbre 53 | 42.5 | 42.5 | 15 | | | |
| Nbre 54 | 42.5 | 42.5 | | 15 | | |
| Nbre 55 | 42.5 | 42.5 | | | 15 | |
| Nbre 56 | 42.5 | 42.5 | | | | 15 |
| Nbre 70 | 40 | 40 | | 20 | | |

HMDA stands for hexamethylene diamine
TAC stands for triammonium citrate
The compositions showed active solids concentrations of 73.9, 76.9, 75.0, 75.6 and 77.6, respectively, thus meeting the viscosity requirement close to a maximum of 500 cP at 25° C. (Brookfield DVII+Pro viscometer with small sample adapter).

The above solid binder compositions and liquid binder compositions may be used as such or in combination with one another. Combinations of liquid and solid binder compositions may advantageously vary from 5/95 to 50/50.

Alternatively, said formulations, more specifically the liquid formulations may be combined with a phenol formaldehyde based binder composition, for example a solid phenol formaldehyde binder composition or other binder resin known in the art.

The resinated friction mix may then be molded as desired for a brake pad or brake shoe and subjected to curing under temperature and pressure conditions as required.

The quality of friction lining is assessed on the basis of coefficient of friction, wear, wear of counter (friction) surface, and temperature dependence of these. Brake pads also need to be water resistant and maintain their brake force under wet conditions. Tests with relevant brake pads prepared as described above from a standard friction mix have shown results comparable to corresponding materials bonded with phenol based binder resin.

### EXAMPLE 2: CURED BINDER ANALYSIS

Binder resin obtained by reacting (i) dextrose monohydrate with monoammonium phosphate and (ii) dextrose monohydrate with diammonium phosphate was subjected to a temperature resistance test.

The tested binder recipes were as follows:
Binder 1: 20.13 parts dextrose monohydrate (at 90.9%); 11.70 parts monoammoniumphosphate (at 98%) in 18.17 parts water
Binder 2: 24.09 parts dextrose monohydrate (at 90.9%); 8.10 parts diammoniumphosphate (at 99%) in 17.81 parts water

The liquid components were dissolved in an appropriate amount of water. The components were allowed to cure to form the relevant resin samples.

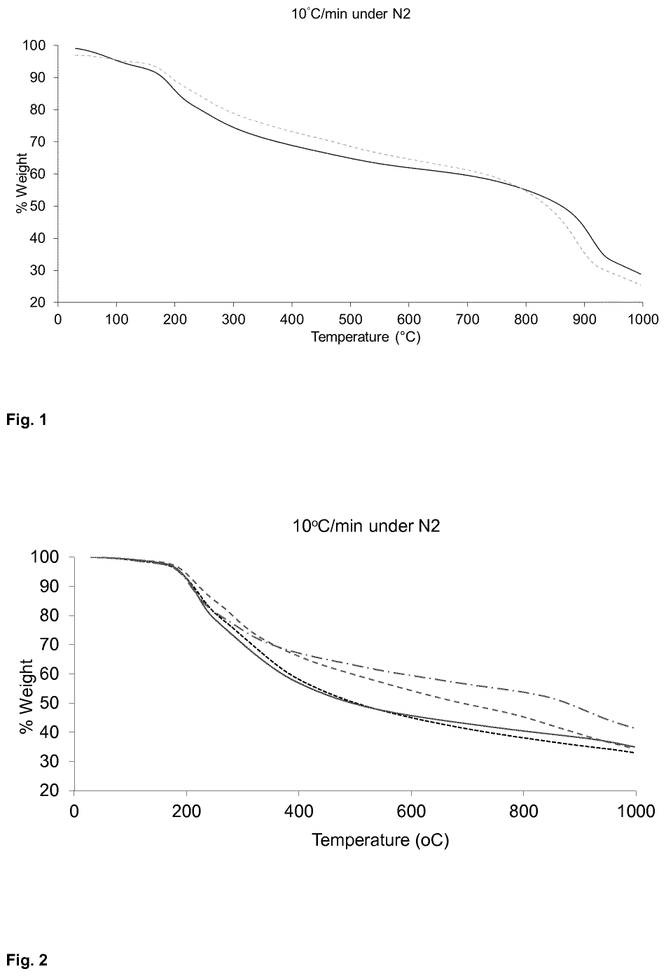

The resin samples were placed in a standard Thermogravimetric Analysis (TGA) analytical instrument and weight loss of the resin samples was measured while ramping the temperature at a rate of 10° C. per minute, under nitrogen atmosphere, as is common for testing phenolic resins and refractories. As can be seen from the graph of FIG. 1, the carbohydrate-based resin samples resist well to high temperatures. It has surprisingly been found that their temperature resistance is as good as or at least comparable to that of a commonly used PF resin.

### EXAMPLE 3

A similar test was performed with the following binder compositions:

| | | | | | Ratio |
|---|---|---|---|---|---|
| | Dextrose | Citric ac | Ammonia | DAP | DMH/CA or |
| Binder | MH 90.9% | MH 91.4% | 25% | 98% | DMH/DAP |
| A | 99.0 | 10.9 | 12.8 | | 90/10 |
| B | 99.0 | | 4.0 | 10.2 | 90/10 |
| C | 93.5 | 16.4 | 19.2 | | 85/15 |
| D | 93.5 | | 19.2 | 15.3 | 85/15 |

The binder compositions were allowed to cure and prepared in binder resin samples. On the graph of FIG. 2, the temperature behaviour (loss of weight) by temperature ramp up at 10° C./min, under nitrogen atmosphere, of Binder A is shown in dotted line; Binder B in dashed line; Binder C in solid line and Binder D in dashdotted line. Again, it has been surprisingly found that the tested resins behave very well under such temperature conditions, similarly to phenolic binders.

1. A composite friction lining material comprising a friction mix and a binder resin, wherein the binder resin comprises a carbohydrate based binder resin, the carbohydrate based binder resin being obtained from a carbohydrate component and a cross-linker, wherein the cross-linker is selected from ammonium salts of inorganic acid, carboxylic acids, salts, for example ammonium salts thereof, ester or anhydride derivatives thereof, an amine component and/or combinations thereof.

2. The composite friction lining material of claim 1 wherein the carbohydrate based binder resin is a polyester type resin binder obtainable from a carbohydrate component and compounds bearing carboxylic acid functional groups, or anhydride or salt derivatives thereof.

3. The composite friction lining material of claim 2 wherein the carboxylic acid functions bearing compound is selected from monocarboxylic acids as well as polycarboxylic acids, salts and anhydride derivatives thereof, the “polycarboxylic acid” being a dicarboxylic, tricarboxylic, tetracarboxylic, pentacarboxylic, or a monomeric polycarboxylic acid, as well as a polymeric polycarboxylic acid, and combinations thereof.

4. The composite friction lining material of claim 1 wherein the carbohydrate based binder resin is a melanoïdin type resin binder obtainable from a carbohydrate and a nitrogenous cross-linker, wherein the carbohydrate component includes one or more reducing sugars, such as a monosaccharide in its aldose or ketose form, including a triose, a tetrose, a pentose, a hexose, or a heptose, or yields one or more reducing sugars in situ under thermal curing conditions; or a polysaccharide; or combinations thereof, and wherein the nitrogenous cross-linker is selected from ammonium salts of inorganic acid, ammonium salts of carboxylic acids, ester or anhydride derivatives thereof, amine components or salts thereof, and/or combinations thereof.

5. The composite friction lining material of claim 4 wherein the inorganic acid is selected from phosphoric, sulphuric, nitric and carbonic acid.

6. The composite friction lining material of claim 4 wherein the amine component is selected from polyamine functional compounds comprising primary and/or secondary amine functional groups, such as a polyamine having the formula of H₂N-Q-NH₂, wherein Q is an alkyl, cycloalkyl, heteroalkyl, or cycloheteroalkyl, each of which may be optionally substituted, polyethyleneimine (PEI), polyninyl amine, polyether amine, polylysine or linear or branched polyetheramines, carbamates or amino acids or proteins.

7. The composite friction lining material of claim 1 wherein the dry weight ratio of carbohydrate component to cross-linker ranges from 2 to 20, preferably from 2 to 15, more preferably from 2.5 to 10.

8. The composite friction lining material of claim 1 further comprising a different resin, such as a phenolformaldehyde resin or other resin known in the art.

9. The composite friction lining material of claim 1 further comprising one or more adjuvants, for example coupling agents, waxes, dyes, release agents, antifungal and/or antibacterial agents, formaldehyde scavengers, hydrophobes, catalysts, anti-caking additives, lubricants, such as fumed silica, dedusting oils, flame retardants, fillers and/or other additives currently used in binder compositions.

10. A process for the manufacture of a composite friction lining material, comprising intimately mixing the binder components of the binder composition and particulate materials of the friction mix, subjecting the mixture to heat in order to promote the reaction between the components of the binder composition and allowing for curing of the reaction product obtained.

11. A brake pad, brake shoe or clutch disc comprising a composite friction lining material according to claim 1.
